(19) United States
(12) Patent Application Publication
(10) Pub. No.: US 2026/0291752 A1
(43) Pub. Date: Sep. 24, 2026

(54) SELECTIVE MEDIA AUTHENTICATION OF VIDEO STREAMS USING SUBPICTURES

(71) Applicants: Dolby Laboratories Licensing Corporation, San Francisco, CA (US); DOLBY INTERNATIONAL AB, Dublin (IE)

(72) Inventor: Iraj SODAGAR, Los Angeles, CA (US)

(73) Assignees: Dolby Laboratories Licensing Corporation, San Francisco, CA (US); DOLBY INTERNATIONAL AB, Dublin (IE)

(21) Appl. No.: 19/650,227

(22) Filed: Apr. 16, 2026

Related U.S. Application Data
(63) Continuation-in-part of application No. PCT/US2026/019767, filed on Mar. 18, 2026.
(60) Provisional application No. 63/776,474, filed on Mar. 24, 2025.
(60) Provisional application No. 63/888,131, filed on Sep. 25, 2025.

(51) Int. Cl. H04L 9/32; H04N 19/169; H04N 19/70

(52) U.S. Cl. CPC H04L 9/3247; H04N 19/188; H04N 19/70

(57) ABSTRACT

Methods and signaling are described for selective media authentication for video content. Example signaling based on a supplemental enhancement information messaging for digital signed content includes: implicit or explicit signaling that an entire picture (e.g., all of its segments) is authenticated with a single digitally signed content (DSC) message, modulo-n DSC signaling, wherein the same DSC message is implied to be repeated every n NAL units, a repeat flag indicating a repeat of a previous DSC message, a flag indicating a single DSC message for all NAL units tagged in an inclusion array of a picture unit (PU), and picture segment ID signaling

### CROSS-REFERENCE TO RELATED APPLICATIONS

This application is a continuation in part (CIP) of PCT Application with Ser. No. PCT/US2026/019767, filed on Mar. 18, 2026, which claims the benefit of priority to U.S. Provisional Patent Application Ser. No. 63/776,474, filed on Mar. 24, 2025, and U.S. Provisional Patent Application Ser. No. 63/888,131, filed on Sep. 25, 2025, each of which is incorporated by reference herein in its entirety.

### TECHNOLOGY

The present document relates generally to images and video sequences. More particularly, embodiments of the present invention relate to using subpictures to include or exclude areas of pictures during media authentication.

### BACKGROUND

In 2020, the MPEG group in the International Standardization Organization (ISO), jointly with the International Telecommunications Union (ITU), released the first version of the Versatile Video Coding Standard (VVC), also known as H.266 (Ref. [1]). More recently, the same group has been working on the development of the next generation coding standard that provides improved coding performance over existing video coding technologies. As part of this investigation, new coding techniques and tools for secure video streaming are also examined.

When transmitting digital content (such as documents, e-mails, and the like), digital signatures act as an electronic “stamp” or seal of authenticity. Currently, media bitstreams, such as video bitstreams, do not provide mechanisms for authentication or verification of the media content or parts thereof. In particular, the video bitstreams produced via standardized video coding algorithms, such as VVC, do not offer mechanisms for authentication or verification.

As appreciated by the inventors here, improved techniques for media authentication of video streams are desired, and they are described herein.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not be assumed to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts an example pixel structure for using subpictures for media authentication according to an embodiment of this invention;

FIG. 2 depicts an example process of selective media authentication according to an embodiment of this invention; and

FIGS. 3A-3C depict examples of modulo-N signaling for media authentication according to embodiments of this invention.

### DESCRIPTION OF EXAMPLE EMBODIMENTS

Example embodiments that relate to media authentication in video coding are described herein. In the following description, for the purposes of explanation, numerous specific details are set forth in order to provide a thorough understanding of the various embodiments of the present invention. It will be apparent, however, that the various embodiments of the present invention may be practiced without these specific details. In other instances, well-known structures and devices are not described in exhaustive detail, in order to avoid unnecessarily occluding, obscuring, or obfuscating embodiments of the present invention.

### SUMMARY

Example embodiments described herein relate to media authentication in video coding. Proposed syntax and semantics for more efficient media authentication include:
implicit or explicit signaling that an entire picture (e.g., all of its segments) is authenticated with a single digitally signed content (DSC) message;
modulo-n DSC signaling, wherein the same DSC message is implied to be repeated every n NAL units;
a repeat flag indicating a repeat of a previous DSC message;
a flag indicating a single DSC message for all NAL units tagged in an inclusion array of a picture unit (PU); and
picture segment ID signaling

### Video Authentication

In a typical media authentication scenario, the decoder authenticates the content by performing some form of signature detection, using for example a hash function to map data from the content into a fixed-size output, denoted as hash. In video transmission, it is possible that an operator may want to exclude a certain area of each picture, say the location of a logo, advertisement, or other overlay, from such signature detection computations. For example, in a video sequence, a desired region (x, y, w, h) may be designated as an exclusion area, where (x, y) denotes the location of the area (e.g., the upper length corner) with respect to the picture's origin (say, the top left corner of its active area) and (w, h) represent, say, in pixels, the width and height of the region respectively. Since the video is encoded in the compressed bitstream, the portion of the bitstream that represents the excluded region (x, y, w, h) needs to be signaled using high-level syntax or metadata, so it can be excluded in the calculations of the digital signature.

In an alternative scenario, an operator may prefer to explicitly specify which areas of the picture need to be used for signature detection. Then, such information. e.g., rᵢ=(xᵢ, yᵢ, wᵢ, hᵢ) values, for regions rᵢ, where i=1, 2, . . . , N, where N denotes the total number of such regions, needs to also be included in the bitstream as high-level syntax or metadata.

In an example embodiment, to support included or excluded picture areas for media authentication, the video sequence is encoded as a collection of two or more subpictures. A video coding scheme that supports subpictures coding enables breaking a frame of video into multiple regions, each of which is called a subpicture. In such an encoding scheme, the portions of the bitstream that represent a subpicture are uniquely identified. Furthermore, the encoding scheme may optionally limit the encoding of a subpicture to be independent from the other subpictures (i.e. no intra/inter-prediction is allowed across subpictures), hence enabling the possibility of removing the portions of the bitstream that belong to the subpicture or replacing them with the corresponding coded bitstreams, of another content, effectively replacing the original content of the subpicture with the new content in the compressed domain.

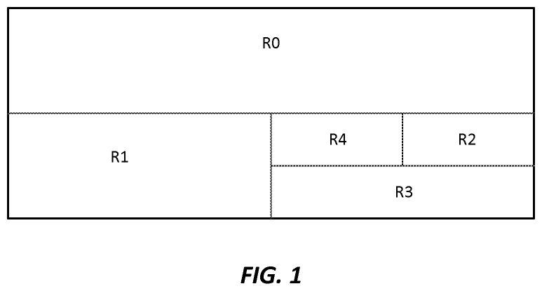

In VVC (Ref. [1]), a subpicture is defined as a rectangular region of one or more slices within a picture. A slice is defined as an integer number of complete tiles or an integer number of consecutive complete coding tree units (CTU) rows within a tile of a picture that are exclusively contained in a single NAL unit. Thus, each subpicture is defined by its top left corner coordinates (x, y) and its width and height (w, h), all in units of coding tree units (CTUs) (i.e., the coordinate x, y are located at the corner of a CTU, and w and h denote the width and height as the number of CTUs in each direction. As an example, without limitation, FIG. 1 depicts a picture subdivided into five subpictures: R0 to R4. As an example, R4 may be signaled as the excluded area, while areas R0 to R3 together define the area to be used for authentication. From VVC:
network abstraction layer (NAL) unit: A syntax structure containing an indication of the type of data that follows and bytes containing that data in a manner that enables the extraction of a string of data bits from the syntax structure.

### Selective Authentication Using SEI Messaging

Recently, a proposed “digitally signed content supplemental enhancement information (DSC SEI)” message (Ref. [2]) defines three SEI messages for content verification: initialization (DSCI), selection (DSCS) and verification (DSCV). As discussed in Ref.[2], the DSCI SEI message with a particular dsci_id value provides information about the secure hash algorithm used for calculating message digests, which are used together with the digital signatures present in the associated DSCV SEI messages to verify that the coded video has been produced by the content provider that identifies itself via a digital certificate for all verification substreams in the current verification period (i.e., the verification period containing the current DSCI SEI message). It further provides information about the digital signature algorithm used and the public key of the content provider.

In a first embodiment, it is proposed to extend the DSC SEI message to also list the subpictures that are to be excluded from the content verification associated with this initialization SEI. An example of the proposed new syntax is indicated in Table 1 with an Italic font.

TABLE 1
Example of DSCI SEI message modified to support excluded subpictures

| | Descriptor |
|---|---|
| digitally_signed_content_initialization( payloadSize ) { | |
| dsci_id | u(8) |
| dsci_hash_method_type | u(8) |
| dsci_key_source_uri | st(v) |
| dsci_num_verification_substreams_minus1 | ue(v) |
| for( i = 1; i <= dsci_num_verification_substreams_minus1; i++ ) | |
| for( j = 0; j < i ; j++ ) | |
| dsci_ref_substream_flag[ i ][ j ] | u(1) |
| dsci_key_retrieval_mode_idc | ue(v) |
| if( dsci_key_retrieval_mode_idc = = 1){ | |
| dsci_use_key_register_idx_flag | u(1) |
| if( dsci_use_key_register_idx_flag ) | |
| dsci_key_register_idx | ue(v) |
| } | |
| dsci_content_uuid_present_flag | u(1) |
| if( dsci_content_uuid_present_flag) | |
| dsci_content_uuid | u(128) |
| dsci_{—}exclusion_{—}flag | u(1) |
| if( dsci_{—}exclusion_{—}flag ){ | |
| dsci_{—}exclud_{—}subpic_{—}num_{—}minus1 | u(8) |
| dsci_{—}exclud_{—}subpic_{—}id_{—}len_{—}minus1 | u(4) |
| for(i = 0; i <= dsci_{—}exclud_{—}subpic_{—}num_{—}minus1; i++ ) | |
| dsci_{—}exclud_{—}subpic_{—}id[i] | u(v) |
| } | |
| } | |

The proposed new semantic are:
dsci_exclusion_flag equal to 1 indicates that one or more subpictures are excluded from the content verification. dsci_exclusion_flag equal 0 indicates no subpicture is excluded in the verification calculation.
dsci_excud_subpic_num_minus1 plus 1 indicates the number of subpictures that are excluded in the content verification. This value shall not be larger than the existing subpictures in the coded stream. For instance, in the case of VVC (ISO/IEC 23009-3), this value shall be smaller than or equal to sps_num_subpics_minus1. dsci_excud_subpic_id_len_minus1 plus 1 specifies the number of bits used to represent the syntax element dsci_exclud_subpic_id[i]. This value shall be equal to sps_subpic_id_len_minus1.
dsci_exclud_subpic_id[i] specifies the subpicture ID of the i-th subpicture that is excluded in this content verification. The length of the dsci_exclud_subpic_id[i] syntax element is dsci_exclud_subpic_id_len_minus1+1 bits. This value shall be identical to one of the subpicture id values that are signaled in the bitstream. For instance, in the case of VVC (ISO/IEC 23009-3), it shall be identical to one of sps_subpic_id[i] or pps_subpic_id[i], whichever is present in the bitstream.

To exclude one or more regions of interest (ROIs) from signature authentication, during encoding, an encoder divides the picture areas to various subpictures, such that a subset of them define the excluded ROI. During the encoding, a DSCI list is generated that lists the subpicture IDs that represent the excluded ROI. Any update to the DSCI includes the update to the subpicture IDs that are excluded, if any. The update can remove the excluded ROI all together. In calculation of the signature, the following pseudocode may used:

```
        while (! (End of CVS)){
          if ( current NAL = coded sliced NAL)
            for( i= 0; i <= dsci_exclud_subpic_num_minus1; i++ ){
              if (current NAL's sh_subpuc_id != dsci_exclud_subpic_id[i])
                  continue to calculate the digital signature (e.g., as defined in
sections 8.39 and 8.40 of Ref.[2]);
                }
```

Note: CVS stands for coded video sequence
and NAL stands for Network Abstraction Layer.

In a receiver, after the receiver detects the DSCI SEI message with dsci_exclusion_flag set to 1, it monitors the coded sliced NALs and filters the NALs that belong to the list of excluded subpictures by matching the sh_subpic_id of the slice header to the list of excluded subpicture IDs in DSCI. The same pseudocode as above can be used for calculating the digital signatures at the receiver.

In a second embodiment, instead of extending the existing DSCI SEI message, one may define a new SEI message, say the digital signed content exclusion SEI message. An example of such a message is provided in Table 2.

TABLE 2
Example of DSC exclusion SEI message

| | De- |
|---|---|
| | scriptor |
| digitally_signed_content_exclusion areas(payloadSize ) { | |
| dsce_id | u(8) |
| dsci_exclusion_flag | u(1) |
| if (dsci_exclusion_flag){ | |
| dsci_exclud_subpic_num_minus1 | u(8) |
| dsci_exclud_subpic_id_len_minus1 | u(4) |
| for( i = 0; i <= dsci_exclud_subpic_num_minus1; i++ ) | |
| dsci_exclud_subpic_id[i] | u(v) |
| } | |
| } | |

The semantics and the digital signature encoding and decoding processes remain the same as those discussed earlier. Furthermore,
dsce_id contains an identifying number that may be used to identify the subpictures to be excluded for verifying that the coded video has been produced by a content provider. The digitally signed content exclusion SEI message identifies the subpictures to be excluded for verifying the digital signature of a substream indicated in a digitally signed content initialization SEI message indicated by dsci_id equal to dsce_id.

When a CVS does not contain a digitally signed content initialization SEI message identified by dsci_id equal to dscv_id, CLVSs (coded layer video sequences) of the CVS shall not contain digitally signed content exclusion SEI message identified by dsci_id equal to dsce_id. When an access unit (AU) contains both a digitally signed content initialization SEI message identified by dsci_id equal to dsce_id and a digitally signed content exclusion SEI message identified by dsci_id equal to dsce_id, the digitally signed content initialization SEI message shall precede the digitally signed content exclusion SEI message.

The two proposed signaling methods allow the verification of various subpicture sets by assigning a different exclusion list of subpictures to DSCIs with different dsci_id (or dsce_id). In this approach, each dsci with unique dsci_id, includes the list of excluded subpictures. Therefore, various regions of interest (such as overlays) can be signaled by excluding all subpicture IDs that are not included in the region of interest. Then for each dsci_id, only the coded sliced NALs that are included in the ROI are used for calculating the signature.

In some applications, instead of signaling excluded ROIs it may be beneficial to signal the list of ROIs to be included when calculating the digital signature. Using again the DSCI SEI message as a basis, Table 3 provides an example, where the new syntax is depicted in Italics.

TABLE 3
Example of a DSCI SEI message modified to support included subpictures

| | Descriptor |
|---|---|
| digitally_signed_content_initialization( payloadSize ) { | |
| dsci_id | u(8) |
| dsci_hash_method_type | u(8) |
| dsci_key_source_uri | st(v) |
| dsci_num_verification_substreams_minus1 | ue(v) |
| for( i = 1; i <= dsci_num_verification_substreams_minus1; i++ ) | |
| for( j = 0; j < i ; j++ ) | |
| dsci_ref_substream_flag[ i ][ j ] | u(1) |
| dsci_key_retrieval_mode_idc | ue(v) |
| if( dsci_key_retrieval_mode_idc = = 1){ | |
| dsci_use_key_register_idx_flag | u(1) |
| if( dsci_use_key_register_idx_flag ) | |
| dsci_key_register_idx | ue(v) |
| } | |
| dsci_content_uuid_present_flag | u(1) |
| if( dsci_content_uuid_present_flag) | |
| dsci_content_uuid | u(128) |
| dsci_{—}inclusion_{—}flag | u(1) |
| if(dsci_{—}inclusion_{—}flag){ | |
| dsci_{—}includ_{—}subpic_{—}num_{—}minus1 | u(8) |
| dsci_{—}includ_{—}subpic_{—}id_{—}len_{—}minus1 | u(4) |
| for(i = 0; i <= dsci_{—}includ_{—}subpic_{—}num_{—}minus1; i++ ) | |
| dsci_{—}includ_{—}subpic_{—}id[i] | u(v) |
| } | |
| } | |

With semantics:
dsci_inclusion_flag equal to 1 indicates that one or more subpictures are included in the content verification. dsci_inclusion_flag equal 0 indicates all subpictures are included in this content verification.
dsci_includ_subpic_num_minus1 plus 1 indicates the number of subpictures that are included in this content verification. This value shall not be larger than the existing subpictures in the coded stream. For instance, in the case of VVC (ISO/IEC 23009-3), this value shall be smaller than or equal to sps_num_subpics_minus1.
dsci_includ_subpic_id_len_minus1 plus 1 specifies the number of bits used to represent the syntax element dsci_includ_subpic_id[i]. This value shall be equal to sps_subpic_id_len_minus1.
dsci_includ_subpic_id[i] specifies the subpicture ID of the i-th subpicture that is included in this content verification. The length of the dsci_includ_subpic_id[i] syntax element is dsci_includ_subpic_id_len_minus1+1 bits. This value shall be identical to one of the subpicture ID values that are signaled in the bitstream. For instance, in the case of VVC (ISO/IEC 23009-3), it shall be identical to one of sps_subpic_id[i] or pps_subpic_id[i], whichever is present in the bitstream.

During encoding, to include one or more regions of interest (ROIs) for signature authentication using ROI-dependent content verification, an encoder divides the picture areas to various subpictures, such that a subset of them defines the desired ROI. During the encoding, a DSCI list is generated that lists the subpicture IDs that represent the included ROI. Any update to the DSCI includes the update to the subpicture IDs that are included, if any. In calculation of the signature, the following pseudocode may be used:

```
          while (! (End of CVS)) {
            if ( current NAL = coded sliced NAL)
              for( i = 0; i <= dsci_includ_subpic_num_minus1; i++ ){
                if (current NAL's sh_subpuc_id == dsci_includ_subpic_id[i])
                    continue to calculate the digital signature (e.g., as defined in
sections 8.39 and 8.40 of Ref.[2]);
              }
```

In a receiver, after the receiver detects the DSCI SEI message with dsci_inclusion_flag set to 1, it monitors the coded sliced NALs and filters the NALs that belong to the list of included subpictures by matching the sh_subpic_id of the slice header to the list of included subpicture IDs in DSCI. The same pseudocode as above can be used for calculating the signatures at the receiver.

In another embodiment, instead of extending the existing DSCI SEI message one may define a new SEI message, say the digital signed content inclusion SEI message. Table 4 depicts an example of such a message.

TABLE 4
Example of DSC inclusion SEI message

| | De- |
|---|---|
| | scriptor |
| digitally_signed_content_inclusion areas( payloadSize ) { | |
| dscii_id | u(8) |
| dsci_inclusion_flag | u(1) |
| if ( dsci_inclusion_flag){ | |
| dsci_includ_subpic_num_minus1 | u(8) |
| dsci_includ_subpic_id_len_minus1 | u(4) |
| for( i = 0; i <= dsci_includ_subpic_num_minus1; i++ ) | |
| dsci_includ_subpic_id[i] | u(v) |
| } | |
| } | |

dscii_id contains an identifying number that may be used to identify the subpictures to be included for verifying that the coded video has been produced by a content provider.

The digitally signed content inclusion SEI message identifies the subpictures to be included for verifying the digital signature of a substream indicated in a digitally signed content initialization SEI message indicated by dsci_id equal to dscii_id.

When a CVS does not contain a digitally signed content initialization SEI message identified by dsci_id equal to dscv_id, CLVSs (coded layer video sequences) of the CVS shall not contain digitally signed content inclusion SEI message identified by dsci_id equal to dscii_id.

When an access unit (AU) contains both a digitally signed content initialization SEI message identified by dsci_id equal to dscii_id and a digitally signed content inclusion SEI message identified by dsci_id equal to dscii_id, the digitally signed content initialization SEI message shall precede the digitally signed content inclusion SEI message.

### Combining Excluding and Including Digital Signature ROIs

In certain applications it may be suitable to use both excluded and included ROIs for digital signature detection. For example, an encoder may separate the pictures into two or more areas: a) areas that are the main picture and b) areas that are suitable for overlays. Then a receiver can detect the authenticity of both the main picture areas and the overlay areas independently of each other. In an example implementation:
The encoder uses exclusion signaling to signal the overlay area, so a first digital signature is computed for the main area
The encoder creates a second, separate, digital signature for the overlay area by signaling inclusion of the overlay area
The list of subpictures being signaled is identical in both cases, but with a different dsci_id value. This allows a receiver to validate each digital signature independently of each other, thus verifying independently the authenticity of both the main area and the overlay area.

In an embodiment, the syntax of inclusion or exclusion in Tables 1 and 3 (or Tables 2 and 4) may be combined as in Tables 5 and 6 using a 2-bit selective authentication mode parameter (e.g., dsci_selective_auth_mode).

TABLE 5
Example of a DSCI SEI message modified to support selective authentication

| | Descriptor |
|---|---|
| digitally_signed_content_initialization( payloadSize ) { | |
| dsci_id | u(8) |
| dsci_hash_method_type | u(8) |
| dsci_key_source_uri | st(v) |
| dsci_num_verification_substreams_minus1 | ue(v) |
| for( i = 1; i <= dsci_num_verification_substreams_minus1; i++ ) | |
| for( j = 0; j < i ; j++ ) | |
| dsci_ref_substream_flag[ i ][ j ] | u(1) |
| dsci_key_retrieval_mode_idc | ue(v) |
| if( dsci_key_retrieval_mode_idc = = 1){ | |
| dsci_use_key_register_idx_flag | u(1) |
| if( dsci_use_key_register_idx_flag ) | |
| dsci_key_register_idx | ue(v) |
| } | |
| dsci_content_uuid_present_flag | u(1) |
| if( dsci_content_uuid_present_flag) | |
| dsci_content_uuid | u(128) |
| dsci_{—}selective_{—}auth_{—}mode //01: exclusion, 11: inclusion | u(2) |
| if(dsci_{—}selective_{—}flag != 0){ | |
| dsci_{—}selective_{—}subpic_{—}num_{—}minus1 | u(8) |
| dsci_{—}selective_{—}subpic_{—}id_{—}len_{—}minus1 | u(4) |
| for(i = 0; i <= dsci_{—}selective_{—}subpic_{—}num_{—}minus1; i++ ) | |
| dsci_{—}selective_{—}subpic_{—}id[i] | u(v) |
| } | |
| } | |

TABLE 6
Example of DSC selective authentication SEI message

| | Descriptor |
|---|---|
| digitally_signed_content_selective areas( payloadSize ) { | |
| dsci_id | u(8) |
| dsci_selective_auth_mode //01: exclusion, 11: inclusion | u(2) |
| if ( dsci_selective_flag != 0){ | |
| dsci_selective_subpic_num_minus1 | u(8) |
| dsci_selective_subpic_id_len_minus1 | u(4) |
| for( i = 0; i <= dsci_selective_subpic_num_minus1; i++ ) | |
| dsci_selective_subpic_id[i] | u(v) |
| } | |
| } | |

dsci_selective_auth_mode equal to 1 indicates that one or more subpictures are excluded in the content verification. dsci_selective_auth_mode equal to 3 indicates that one or more subpictures are included in the content verification. dsci_selective_auth_mode equal to 0 indicates that all subpictures are included in this content verification.
dsci_selective_subpic_num_minus1 plus 1 indicates the number of subpictures that are excluded or included in this content verification. This value shall not be larger than the existing subpictures in the coded stream. For instance, in the case of VVC (ISO/IEC 23009-3), this value shall be smaller than or equal to sps_num_subpics_minus1.
dsci_selective_subpic_id_len_minus1 plus 1 specifies the number of bits used to represent the syntax element dsci_selective_subpic_id[i]. This value shall be equal to sps_subpic_id_len_minus1.
dsci_selective_subpic_id[i] specifies the subpicture ID of the i-th subpicture that is excluded or included in this content verification. The length of the dsci_selective_subpic_id[i] syntax element is dsci_selective_subpic_id_len_minus1+1 bits. This value shall be identical to one of the subpicture ID values that are signaled in the bitstream. For instance, in the case of VVC (ISO/IEC 23009-3), it shall be identical to one of sps_subpic_id[i] or pps_subpic_id[i], whichever is present in the bitstream.

With respect to the DSC selective authentication SEI message, dscis_id contains an identifying number that may be used to identify the subpictures to be included or excluded for verifying that the coded video has been produced by a content provider.

The digitally signed content selective authentication SEI message identifies the subpictures to be included or excluded for verifying the digital signature of a substream indicated in a digitally signed content initialization SEI message indicated by dsci_id equal to dscis_id.

When a CVS does not contain a digitally signed content initialization SEI message identified by dsci_id equal to dscv_id, CLVSs (coded layer video sequences) of the CVS shall not contain digitally signed content inclusion SEI message identified by dsci_id equal to dscis_id.

When an access unit (AU) contains both a digitally signed content initialization SEI message identified by dsci_id equal to dscis_id and a digitally signed content selective authentication SEI message identified by dsci_id equal to dscis_id, the digitally signed content initialization SEI message shall precede the digitally signed content selective authentication SEI message.

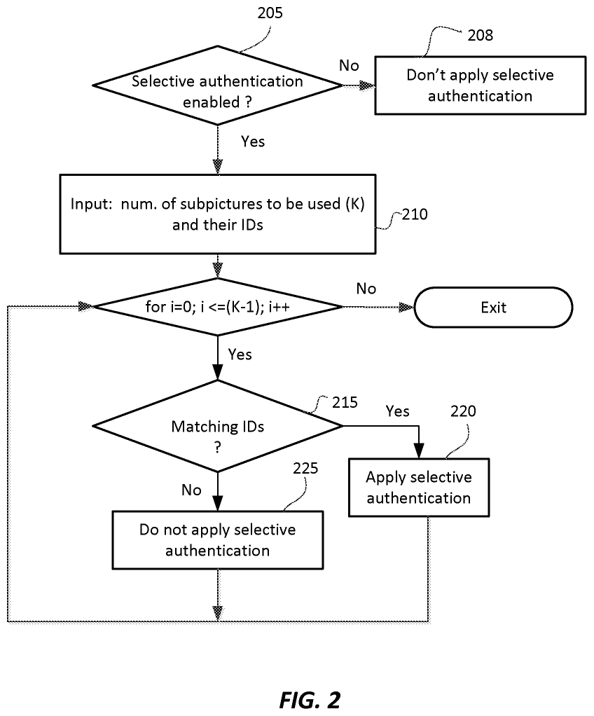

An example of a process for selective authentication is also depicted in FIG. 2. As depicted in FIG. 2, in step 205, a processor first decides or detects whether selective authentication is enabled or not. If there is no selective authentication, then the processor applies authentication using the whole picture (208). If there is selective authentication, then, in step 210, the processor reads the number of selected subpictures to be processed (K) during selective authentication and their IDs (e.g., dsci_selective_subpic_id[i] values). Next (215), it monitors the coded sliced NALs and filters the NALs that belong to the list of the selected subpictures. If there is a match, then selective authentication (i.e., inclusion or exclusion) is applied in computing a digital signature (220), otherwise no selective authentication is applied (225).

### Skipping DSCS SEI Messages

In an embodiment, as depicted in Table 7, one may extend the VSEI Digitally Signed Content SEI messages in Ref. [3] to allow skipping NAL units in a picture unit (PU) during the selection of NALs.

TABLE 7
Example to skip NAL units following the DSCS SEI message

| | Descriptor |
|---|---|
| digitally_signed_content_selection( payloadSize ) { | |
| dscs_id | u(8) |
| dscs_verification_substream_id | u(8) |
| dscs_{—}skip_{—}flag | u(1) |

The new semantic is given by:
dscs_skip_flag equal to 1 indicates that one or more NAL units in the same PU that follows the SEI message in decoding order until the next DSCS SEI message in the PU or the end of the PU, where each of the NAL units is either a non-VCL NAL unit with a NAL unit type identifier among the values in nonVclDigitallySignedNalUnitslist or a VCL NAL unit, are not associated with any message digest for the verification substream indicated by the DSCS SEI message. If dscs_skip_flag is equal to 1, then the value of dscs_verification_substream_id is ignored.

This allows some NALs to be skipped and not to be associated with any message digest. From Ref. [3]:
dscs_id contains an identifying number of a verification system that may be applied for verifying that the coded video represented by the current verification period (i.e., the verification period for dsci_id equal to dscs_id containing the current DSCS SEI message) has been produced by the content provider indicated by the associated DSCI SEI message.
dscs_verification_substream_id specifies the verification substream ID of the verification substream to which the verification substream member NAL units in the current PU are assigned.

Note: embodiments presented herein may use separate verification substreams to separate the authentication of one or more subpictures from the rest of a picture unit. Hence, such applications as subpicture extraction and selective authentication are possible by allowing the inclusion and/or exclusion of regions of interest.

### Enabling Consistency Across PUs During a Verification Period

As appreciated by the inventors, it is important to maintain a consistent subpicture selection across PUs during a verification period. Three alternative embodiments are proposed: a) enforcing a new semantic constraint to existing semantics, b) using new semantics, and c) supporting using multiple DSCS messages with the same dscs_verification_substream_id.

### a) Enforcing a New a Semantic Constraint

In a first embodiment, as shown in Table 8, one may add a constraint to the DSCS extension discussed in Ref. [4] that the value of dscs_picture_segment_id shall be constant across all PUs of a verification period. The text in Italics indicates the additional constraint.

TABLE 8
Example of DSCS SEI messaging with a new semantic
constraint allowing consistency across PUs

| | Descriptor |
|---|---|
| digitally_signed_content_selection( payloadSize ) { | |
| dscs_id | u(8) |
| dscs_verification_substream_id | u(8) |
| dscs_independently_signed_picture_segments_enabled_flag | u(1) |
| if ( dscs_independently_signed_picture_segments_enabled_flag ) | |
| dscs_picture_segment_id | ue(v) |
| } | |

dscs_pictune_segment_id indicates a picture segment ID of a coded picture segment in the PU to which the SEI message applies, for which the coded picture segment is associated to the verification substream with verification substream ID equal to dscs_verification_substream_id. The value of dscs_picture_segment_id shall be in the range of 0 to 1023. This value shall be identical in all PUs of a verification period with identical values of dscs_id and dscs_verification_substream_id.

From Ref. [4]:
dsci_independently_signed_picture_segments_enabled_flag equal to 1 specifies that independent signing of coded picture segments is enabled. dsci_independently_signed_picture_segments_enabled_flag equal to 0 specifies that independent signing of coded picture segments is disabled. When not present, dsci_independently_signed_picture_segments_enabled_flag is inferred to be equal to 0.

The value of dscs_independently_signed_picture_segments_enabled_flag shall be equal to the value of dsci_independently_signed_picture_segments_enabled_flag of the DSCI SEI message with dsci_id equal to dscs_id.

### b) Using New Semantics

In another embodiment, as depicted in Table 9, one may move the signaling of the segment IDs to the DSCI.

TABLE 9
Example of DSCI SEI messaging with signaling of verification
segment and corresponding picture segment IDs

| | Descriptor |
|---|---|
| digitally_signed_content_initialization( payloadSize ) { | |
| ... | |
| for( i = 1; i <= dsci_num_verification_substreams_minus1; i++ ) | |
| for( j = 0; j < i ; j++ ) | |
| dsci_ref_substream_flag[ i ][ j ] | u(1) |
| dsci_independently_signed_picture_segments_enabled_flag | u(1) |
| if (dsci_{—}independently_{—}signed_{—}picture_{—}segments_{—}enabled_{—}flag ){ | |
| dsci_{—}num_{—}separate_{—}picture_{—}segment_{—}minus1 | u(8) |
| for (i = 0; i <= | |
| dsci_{—}num_{—}separate_{—}picture_{—}segment_{—}minus1; i ++ ) | |
| dsci_{—}verification_{—}substream_{—}id | u(8) |
| dsci_{—}picture_{—}segment_{—}id | ue(v) |
| } | |
| } | |

The new syntax elements are:
dsci_num_separate_picture_segment_minus1 plus 1 indicates the number of separate verification substreams that each describes the message digest corresponding to a coded picture segment in every PU in the verification period.
dsci_verification_substream_id specifies the verification substream ID of the verification substream to which the verification substream member NAL units is assigned.
dsci_picture_segment_id indicates a picture segment ID of a coded picture segment in the PU to which the SEI message applies, for which the coded picture segment is associated to the verification substream with verification substream ID equal to dscs_verification_substream_id. The value of dsci_picture_segment_id shall be in the range of 0 to 1023.

The syntax depicted in Italics and the new syntax elements allow defining the subpictures and their corresponding verification substream IDs at DSCI, thus allowing for a consistent subpicture selection across PUs in a verification period.

c) Supporting Multiple DSCS with the Same Dscs_Verification_Substream_Id

In another embodiment, as shown in Italics, one may enable the use of multiple DSCS messages with various subpicture IDs:
The value of dscs_independendy_signed_picture_segments_enabled_flag shall be equal to the value of dsci_independently_signed_picture_segments_enabled_flag of the DSCI SEI message with dsci_id equal to dscs_id.
dscspicture_segment_id indicates a picture segment ID of a coded picture segment in the PU to which the SEI message applies, for which the coded picture segment is associated to the verification substream with verification substream ID equal to dscs_verification_substream_id. The value of dscs_picture_segment_id shall be in the range of 0 to 1023. Inclusion of two or more DSCS, with identical dscs_id and dscs_verafication_substream_id, but with different dscs_picture_segment_id indicates that the pictures segments with those IDs in the PU are all associated to the same verification substream.

### Multiple Subpictures in a Single DSCS

Alternatively, in another embodiment, as depicted in Table 10, one may enable the use of multiple subpicture IDs in a single DSCS.

TABLE 10
Example of enabling multiple subpicture IDs in a single DSCS

| | Descriptor |
|---|---|
| digitally_signed_content_selection( payloadSize ) { | |
| dscs_id | u(8) |
| dscs_verification_substream_id | u(8) |
| dscs_independently_signed_picture_segments_enabled_flag | u(1) |
| if ( dscs_independently_signed_picture_segments_enabled_flag ){ | |
| dscs_{—}num_{—}subpic_{—}minus1 | u(8) |
| for (i = 0; i <= dsci_{—}num_{—}subpic_{—}minus1; i ++ ) | |
| dscs_{—}picture_{—}segment_{—}id | ue(v) |
| } | |
| } | |

Where:
dscs_num_subpic_minus1 plus 1 indicates the number of picture segments that are associated with the verification substream identified by dscs_verification_substream_id.

### Signaling Cross-PU Consistency in DSCI.

In an embodiment, as depicted in Table 11, if both options of cross-PU consistency and inconsistency are desired, one may signal the list of verification substream IDs that are consistent in DSCI. Proposed amendments to the current proposal are shown in Italics.

TABLE 11
Example of signaling consistent verification substreams' IDs in DSCI

| | Descriptor |
|---|---|
| digitally_signed_content_initialization( payloadSize ) { | |
| ... | |
| for( i = 1; i <= dsci_num_verification_substreams_minus1; i++ ) | |
| for( j = 0; j < i ; j++ ) | |
| dsci_ref_substream_flag[ i ][ j ] | u(1) |
| dsci_independently_signed_picture_segments_enabled_flag | u(1) |
| if (dsci_independently_signed_picture_segments_enabled_flag) { | |
| dsci_{—}consistent_{—}picture_{—}segments_{—}enabled_{—}flag | u(1) |
| if (dsci_{—}consistent_{—}picture_{—}segments_{—}enabled_{—}flag){ | |
| dsci_{—}max_{—}picture_{—}segments_{—}minus1 | u(8) |
| for(i = 0; i <= dsci_{—}max_{—}layers_{—}minus1; i++ ) | |
| dsci_{—}consistent_{—}verification_{—}substream_{—}id[i] | u(8) |
| } | |
| } | |

The new syntax elements are:
dsci_consistent_picture_segments_enabled_fiag equal to 1 specifies that one or more subpictures are assigned to one verification substream during the verification period.
dsci_max_pictune_segments_minus1 plus 1 indicates the number of the verification substreams that are consistent by having NALs from specific subpictures.
dsci_consistent_verification_substream_id specifies the verification substream ID of the verification substream where the same picture segment(s) are assigned to in each PU during the verification period.

### Selective Authentication by Signaling Additional Properties of the DSC

In another embodiment, as depicted in Table 12, one may enable selective authentication by defining two new parameters to be added to the DSCI message, to describe additional properties of the DSC. These parameters allow the content author to provide information about the application and authentication characteristics of the digitally signed content SEIs.

TABLE 12
Example of signaling additional properties in a DSCI message

| | Descriptor |
|---|---|
| digitally_signed_content_initialization( payloadSize ) { | |
| dsci_id | u(8) |
| dsci_hash_method_type | u(8) |
| dsci_key_retrieval_mode_idc | ue(v) |
| if( dsci_key_retrieval_mode_idc = = 1 ) { | |
| dsci_use_key_register_idx_flag | u(1) |
| if( dsci_use_key_register_idx_flag ) | |
| dsci_key_register_idx | ue(v) |
| } | |
| dsci_content_uuid_present_flag | u(1) |
| if( dsci_content_uuid_present_flag ) | |
| dsci_content_uuid | u(128) |
| dsci_num_verification_substreams_minus1 | ue(v) |
| for( i = 1; i <= dsci_num_verification_substreams_minus1; i++ ) | |
| for( j = 0; j < i ; j++ ) | |
| dsci_ref_substream_flag[ i ][ j ] | u(1) |
| dsci_vss_implicit_association_mode_flag | u(1) |
| dsci_signed_content_start_flag | u(1) |
| dsci_sei_signing_flag | u(1) |
| dsci_{—}information_{—}flag | u(1) |
| while( !byte_aligned( ) ) | |
| dsci_alignment_zero_bit | f(1) |
| dsci_key_source_uri | st(v) |
| if(dsci_{—}information_{—}flag ){ | |
| dsci_{—}information_{—}uri | st(v) |
| dsci_{—}information_{—}data | st(v) |
| } | |
| } | |

Where the new syntax elements are:
dsci_informationjflag equal to 1 indicates this SEI contains additional information on the DSC application.
dsci_information_uri contains a uniform resource identifier (URI) with syntax and semantics as specified in =ET Internet Standard 66 which identifies the format of dsci_information_data.
dsci_information_data contains the additional information regarding this DSC characteristics. The sematic of this field is defined by dsci_information_uri.

The dsci_information_uri and dsci_information_data can be used to signal the characteristic of the DSC. For instance, the following Table shows a few examples of such use cases.

### Examples of Provided Application Information in DSCI

| | | dsci_information_uri |
|---|---|---|
| Use case | dsci_information_uri value | example value |
| Separate DSC verification for certain | urn:jvet:vsei:dsc:info:separate | “1 2” |
| number of subpictures from the rest of | | (white space separated list |
| PU | | of separated subpicture ids) |
| Selection NAL for propose of reducing | urn:jvet:vsei:dsc:info:reducedcomplexity | N/A |
| computational complexity | | |
| Skipped subpictures in DSC (for | urn:jvet:vsei:dsc:info:skipped | “3 5” |
| applications such as replaceable ROI) | | (white space separated list |
| | | of subpicture ids) |

### Signaling of ROIs Using Scalable Nesting SEIs

In another embodiment, one may also define an alternative approach for signaling an authentication ROI using the scalable nesting SEI, which is defined in Annex D of the H.266 specification (Ref. [1]) and copied herein as Table 13. In an example, the scalable nesting SEI supports the following syntax:

TABLE 13
The employed VVC's Scalable nesting SEI message
for signaling selection/separation of subpictures
for DSC streams or different verification bitstreams

| | Descriptor |
|---|---|
| scalable_nesting( payloadSize ) { | |
| sn_ols_flag | u(1) |
| sn_subpic_flag | u(1) |
| if( sn_ols_flag ) { | |
| sn_num_olss_minus1 | ue(v) |
| for( i = 0; i <= sn_num_olss_minus1; i++ ) | |
| sn_ols_idx_delta_minus1[ i ] | ue(v) |
| } else { | |
| sn_all_layers_flag | u(1) |
| if( !sn_all_layers_flag ) { | |
| sn_num_layers_minus1 | ue(v) |
| for( i = 1; i <= sn_num_layers_minus1; i++ ) | |
| sn_layer_id[ i ] | u(6) |
| } | |
| } | |
| if( sn_subpic_flag ) { | |
| sn_num_subpics_minus1 | ue(v) |
| sn_subpic_id_len_minus1 | ue(v) |
| for( i = 0; i <= sn_num_subpics_minus1; i++ ) | |
| sn_subpic_id[ i ] | u(v) |
| } | |
| sn_num_seis_minus1 | ue(v) |
| while( !byte_aligned( ) ) | |
| sn_zero_bit /* equal to 0 */ | u(1) |
| for( i = 0; i <= sn_num_seis_minus1; i++ ) | |
| sei_message( ) | |
| } | |

In an embodiment, the scalable nesting SEI is employed by using sn_num_subpics_minus1 parameter to define the number of subpictures that are in the ROI. For each subpicture exists a dedicated sei_message that may include one of the following solutions:
solution 1 (DSCS): replacing the DSCS with a scalable nesting SEI containing the DSCS (with no picture_segment_id) in its sei_message( ) with the following constraints; or
solution 2(DSCI): replacing the DSCI with a scalable nesting SEI containing the DSCI in its sei_message( ).

Both solutions allow use of single or multiple subpictures in one verification stream, since either DSCS or DSCI is defined for each subpicture. In both solutions, the following parameters shall be set as the following: sn_ols_flag=0, sn_subpic_flag=1, sn_all_layers_flag=1. Solution 2 provides consistency in a verification period, since the subpictures are defined at the beginning of the verification period. Further, the DSCIs of various subpictures may have the same dsci_id, meaning that the NALs of the corresponding DSCIs are part of the same verification stream. Such DSCIs shall have identical values for the following parameters: dsci_hash_method_type, dsci_key_retrieval_mode_idc, dsci_use_key_register_idx_flag, dsci_key_register_idx, dsci_content_uuid_present_flag, dsci_content_uuid, dsci_num_verification_substreams_minus1, dsci_ref_substream_flag[i][j] for every i and j, dsci_vss_implicit_association_mode_flag, dsci_signed_content_start_flag, dsci_sei_signing_flag, and dsci_key_source_uri.

For solution 1 (DSCS), if the values of dscs_verification_substream_id are identical between two scalable nesting SEIs, then the corresponding subpictures are associated with the same verification substream. For signaling cross-PU consistency one of the methods described earlier can be used (see Tables 8, 9, and 11).

Note: For reference, the semantic of sn_ols_flag, sn_subpic_flag, and sn_all_layers_flag are (Ref.[1]):
sn_ols_flag equal to 1 specifies that the scalable-nested SEI messages apply to specific OLSs. sn_ols_flag equal to 0 specifies that the scalable-nested SEI messages apply to specific layers.
sn_subpic_flag equal to 1 specifies that the scalable-nested SEI messages that apply to specified OLSs or layers apply only to specific subpictures of the specified OLSs or layers. sn_subpic_flag equal to 0 specifies that the scalable-nested SEI messages that apply to specific OLSs or layers apply to all subpictures of the specified OLSs or layers.
sn_all_layers_lag equal to 1 specifies that the scalable-nested SEI messages apply to all layers that have nuh_layer_id greater than or equal to the nuh_layer_id of the current SEI NAL unit. sn_all_layers_flag equal to 0 specifies that the scalable-nested SEI messages might or might not apply to all layers that have nuh_layer_id greater than or equal to the nuh_layer_id of the current SEI NAL unit.

### Additional Considerations for DSC Subpicture Support

During the January 2026 JVET meeting, proponents of Ref. [6] proposed modifications to the Technologies under Consideration (TuC) document (Ref.[5]), using different tools for digitally signed content to achieve the same functionality. The proposal claims less overhead for inserting the SEI message, but it loses various functionalities, such as signaling the picture segment grouping and the ease of extraction functionalities proposed in the TuC. Example embodiments presented in this Section propose new features to the TuC and to Ref. [6], to make both solutions more efficient while maintaining all useful functionality.

Ref [5] does not include a verification stream that includes all NAL units. If the entire picture authentication is needed, it needs to be explicitly signaled by assigning all picture segments to a verification stream. In an embodiment, as depicted in Table 14, it is proposed to add a new flag that indicates the verification substream 0 contains all picture segments. Example syntax, with new elements shown in Italics, is provided in Table 14.

TABLE 14
Example DSCI syntax with new verification flag

| | Descriptor |
|---|---|
| digitally_signed_content_initialization( payloadSize ) { | |
| ... | |
| for( i = 1; i <= dsci_num_verification_substreams_minus1; i++ ) | |
| for( j = 0; j < i ; j++ ) | |
| dsci_ref_substream_flag[ i ][ j ] | u(1) |
| dsci_vss_implicit_association_mode_flag | u(1) |
| dsci_signed_content_start_flag | u(1) |
| dsci_sei_signing_flag | u(1) |
| while( !byte_aligned( ) ) | |
| dsci_alignment_zero_bit | f(1) |
| dsci_key_source_uri | st(v) |
| if( more_data_in_payload( ) && payload_extension_present( ) ) { | |
| SeiExtensionBitsPresentFlag = 1 | |
| dsci_picture_segment_mode_flag | u(1) |
| if ( dsci_picture_segment_mode_flag ) { | |
| dsci_{—}entire_{—}picture_{—}flag | u(1) |
| for( i = dsci_{—}entire_{—}picture_flag; | |
| i <= dsci_num_verification_substreams_minus1; i++ ) { | |
| dsci_num_picture_segments_minus1[ i ] | ue(v) |
| for(j = 0; j <= dsci_num_picture_segments_minus1[ i ]; j++) | |
| dsci_picture_segment_id[ i ][ j ] | ue(v) |
| } | |
| } | |
| } | |

Where:
dsei_entire_pieturejflag equal to 1 specifies that a verification substream with dscs_verification_substream_id=0 signs the entire picture (i.e. contains all picture segments of apicture) in addition to the dsci_num_verification_substreams_minus1 verification substreams defined in the DSCL
dsci_num_verification_substreams_minus1 plus 1 indicates the number of verification substreams for which message digests are calculated and signatures may be present in the associated DSCV SEI messages. The value of dsci_num_verification_substreams_minus1 shall be in the range of 0 to 255, inclusive.

The variable NumVerificationSubstreams is derived as:
NumVerificationSubstreams=dsci_num_verification_substreams_minus1+1.
dsci_num_picture_segments_minus1[i] indicates the number of picture segments that are associated with the verification substream with verification substream ID equal to i. The value of dsci_num_picture_segments_minus1[i] shall be in the range of 0 to 1023, inclusive.
dsci_picture_segment_id[i][j] indicates the j-th picture segment ID of a coded picture segment in the PU to which the SEI message applies, for which the coded picture segment is associated to the verification substream with verification substream ID equal to i. The value of dscs_picture_segment_id [i][j] shall be in the range of 0 to 1023.
dscs_verification_substream_id specifies the verification substream ID of the verification substream to which the verification substream member NAL units in the current PU are assigned.

As depicted in Table 14, by setting the dsci_entire_picture_flag to 1, the verification substream that has its id=0, is used for signing all of the NAL units and therefore all pictures. In this case, no explicit assignment of all picture segments is needed in DSCI. Also, no DSCS is needed for the verification sub-stream with dscs_verification_substream_id=0.

In Ref. [5], each DSCS message is applied to the NAL units that follow that DSCS. The DSCS assigns those NAL units to the verification substream that is indicated in that DSCS. In the case of skipping, those NAL units are not assigned to any verification substream. Therefore, to change the assignment or start skipping, a new DSCS must be inserted.

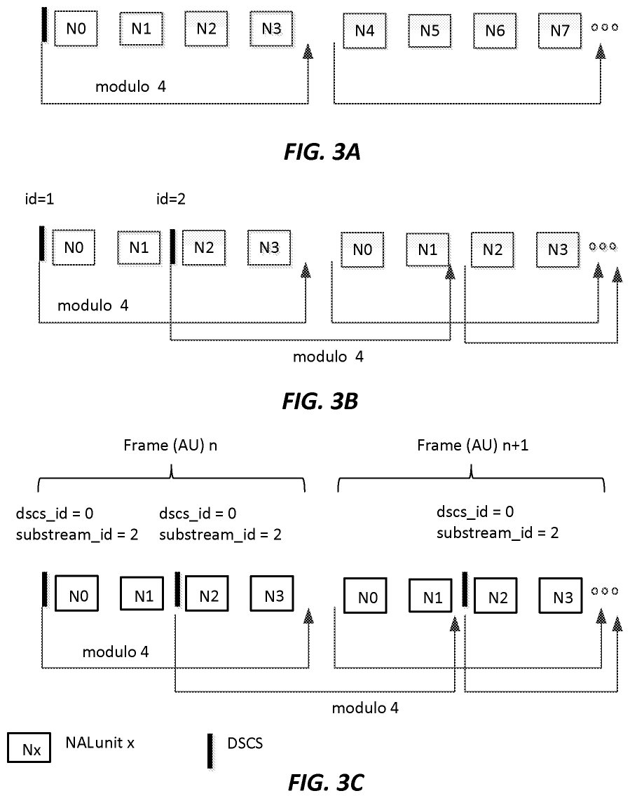

In an embodiment, the concept of modulo-N DSCS is introduced. Under this concept, if a modulo n is signaled in the DSCS, the DSCS is applied after every n NAL units from the NAL unit it is included. Example are depicted in FIGS. 3A-3C.

As depicted in FIG. 3A, the first DSCS is inserted before NAL unit NO. Under modulo-N signaling, given a modulo n value, say n=4, it is now implied that after 4 NALs (e.g., at NAL=4, 8, 16, etc.) an identical such DSCS message exists. Now, if as depicted in FIG. 3B, a second DSCS message (the one with id=2), is also part of the stream, then, with two DSCS (with different verification stream ID numbers), a large number of NAL units are divided between two verification streams. This method is much more efficient than the original TuC design, in which every n NAL unit requires an explicit DSCS.

As an example, assume the verification period includes 60 pictures, and each picture consists of 4 NAL units. The verification substream 1 includes the first two NALs, and verification substream 2 includes the last two NALs. The following Table shows the number of DSCS needed in each design.

Example of Efficiency of the Modulo-n Design for n=4 and Two Verification Substreams

| Design | Number of DSCS |
|---|---|
| TuC | 120 |
| Modulo-n design (n = 4) | 2 |

In this case, the modulo n design saves 118 DVSC NAL units in 60 frames. In general, for F frames, the amount of saving is (F-1)/F. Therefore, this design is very efficient for long verification periods. The modulo-n DSCS can be implemented implicitly or explicitly.

### Implicit Picture-Level DSCS Repeat

One way to extend DSCS is implicit Access Unit (AU)-level repeat. In VVC, an access unit (AU) is defined as “a set of Picture Units (PUs) that belong to different layers and contain coded pictures associated with the same time for output from the decoder picture buffer. In this approach, the DSCS syntax is kept the same, but each DSCS by default is interpreted as AU-level DSCS, meaning if the dscs_picture_segment_mode_flag is set to 1, it is assumed the DSCS inherently repeats (i.e. an equivalent DSCS is in the next AU and is processed) prior to the corresponding VCL (video coding layer) NAL unit that is placed in the current picture, as is shown in FIG. 3A, unless a DSCS appears in the frame in the exact location. This operation is shown in FIG. 3C.

As shown in FIG. 3C, the stream includes one DSCS before NAL unit NO and one DSCS before NAL unit N2 in frame (AU) n. In frame (AU) n+1, the stream only includes one DSCS before NAL unit N2.

The AU-level implicit repeat processes an additional implicit DSCS, identical to DSCS id=1 of frame (AU) n, prior to NAL unit NO of frame (AU) n+1, since there is no explicit DSCS with the same id. However, since in frame (AU) n+1, prior to NAL unit N2, there is an explicit DSCS with the same ID as the one in frame (AU) n prior to NAL unit N2, the new explicit DSCS is processed instead.

The following semantics implements the above solution:
“When processing for selection, if a DSCS SEI exists between (n-1)^{th} and n^{th} VCL NAL unit (DSCS-C) in the current AU, and if a DSCS SEI exists between (n-1)^{th} and n^{th} VCL NAL unit of the immediate prior AU (DSCS-P), that satisfy all the following conditions.
   Identical values for dscs_id in both DSCS-C and DSCS-P
   Identical values for dscs_verification_substream_id in both DSVS-C and DSCS-P
   dscs_picture_segment_mode_flag set to 1 in both DSCS-C and DSCS-P
Then the DSVS-C is processed for selection for the n^{th} VCL NAL unit and after. Otherwise, the DSCS-P is processed for selection for the nth VCL NAL unit and after the current AU.” dscs_picture_segment_mode_flag equal to 1 specifies that signing of coded picture segments is used. dscs_picture_segment_mode_flag equal to 0 specifies that signing of coded pictures is not used.

### Explicit Modulo-n Signaling

As depicted in Table 15, in Italics, one can explicitly signal the modulo-n operation using a flag, e.g., dscs_modulo_n_inclusion_flag.

TABLE 15
Example modulo-n DSCS syntax

| | Descriptor |
|---|---|
| digitally_signed_content_selection( payloadSize ) { | |
| dscs_id | u(8) |
| dscs_verification_substream_id | u(8) |
| if( more_data_in_payload( ) && payload_extension_present( ) ) { | |
| SeiExtensionBitsPresentFlag = 1 | |
| dscs_picture_segment_mode_flag | u(1) |
| if ( dscs_picture_segment_mode_flag ) | |
| dscs_skip_flag | u(1) |
| dscs_{—}modulo_{—}n_{—}inclusion_{—}flag | u(1) |
| if(dscs_{—}modulo_{—}inclusion_{—}flag ) | |
| dscs_{—}modulo_{—}repeat | u(7) |
| } | |
| } | |

Where:
dscs_modulo_n_indusion_flag equal to 1 indicates that the inclusion of NAL units in this verification substream is signaled using a modulo pattern.
dscs_modulo_repeat equal to n, where 0<n<129, indicates that after n NAL units after this DSCS NAL unit, this DSCS NAL unit is processed again, and the same repetition continues after every n NAL unit until a DSCS with identical dscs_id and dscs_verification_substream_id values appears in the bitstream or the end of the verification period, which is indicated with a DSCS with dscs_id and dscs_verification_substream_id values identical to this DSCS's, whichever comes first. The dscs_modulo_repeat equal to 0 indicates that this DSCS is processed once.

In a variation of this design, only the VCL NAL units are content for modulo n operation, i.e., the DSCS NAL unit is processed every n VCL NAL units again until a DSCS with identical dscs_id and dscs_verification_substream_id values appears in the bitstream or the end of the verification period, which is indicated with a DSCS with dscs_id and dscs_verification_substream_id values identical to this DSCS's, whichever comes first. The dscs_modulo_repeat equals 0 indicates that this DSCS is processed once. In this case, if the frames have additional non-VCL NALs, while the number of VCL NALs stays the same in all frames, but some frames might have additional non-VCL NALs, the frequency of DSCS NALs stays the same with respect to VCL NALs.

In order to support both options, a new flag can be added to the syntax as shown in Table 16.

TABLE 16
Example modulo-n DSCS syntax with the
option of counting VCL vs non-VCL NALS

| | Descriptor |
|---|---|
| digitally_signed_content_selection( payloadSize ) { | |
| dscs_id | u(8) |
| dscs_verification_substream_id | u(8) |
| if( more_data_in_payload( ) && payload_extension_present( ) ) { | |
| SeiExtensionBitsPresentFlag = 1 | |
| dscs_picture_segment_mode_flag | u(1) |
| if ( dscs_picture_segment_mode_flag ) | |
| dscs_skip_flag | u(1) |
| dscs_{—}modulo_{—}n_{—}inclusion_{—}flag | u(1) |
| if(dscs_{—}modulo_{—}inclusion_{—}flag ){ | |
| dscs_{—}modulo_{—}repeat | u(7) |
| dscs_{—}modulo_{—}nonvcl_{—}flag | u(1) |
| } | |
| } | |
| } | |

Where:
dscs_modulo_repeat equal to n, where 0<n<129, indicates that after n VCL NAL units after this DSCS NAL unit, this DSCS NAL unit is processed again, and the same repetition continues after every n VCL NAL unit until a DSCS with identical dscs_id and dscs_verification_substream_id values appears in the bitstream or the end of the verification period, which is indicated with a DSCS with dscs_id and dscs_verification_substream_id values identical to this DSCS's, whichever comes first. The dscs_modulo_repeat equal to 0 indicates that this DSCS is processed once.
dscs_modulo_nonvcl_flag equal to 1 indicates that all NAL units are counted in the modulo n operation. dscs_modulo_nonvcl_flag equal to 0 indicated that only VCL NAL units are counted.

### Explicit Modulo-n Picture Based Signaling

In this method, one signals explicitly the modulo-n operation, but for frames (AUs). The syntax is same as Table 15, but the semantics are updated as the following. dscs_modulo_n_indusion_flag equal to 1 indicates that the inclusion of NAL units in this verification substream is signaled using a modulo picture pattern. dscs_modulo_repeat equal to n, where 0<n<129, indicates that after n pictures after the current AU that contains this DSCS NAL unit after m VCL NAL units, this DSCS NAL unit is processed again after m VCL NAL units, and the same repetition continues after every n AU and m VCL NAL until a DSCS with identical dscs_id and dscs_verification_substream_id values appears in the bitstream or the end of the verification period, which is indicated with a DSCS with dscs_id and dscs_verification_substream_id values identical to this DSCS's, whichever comes first. The dscs_modulo_repeat equal to 0 indicates that this DSCS is processed once.

### Explicit Signaling to Repeat DSCS at AU Level

In this method, one can define a DSCS that signals repeating the same DSCSs of the previous AU at this AU. When a Repeat DSCS is observed, the processer assumes the same number of DSCSs's of the previous AU in before every corresponding VCL NAL unit in AU and process the selection of NALs accordingly. Table 17 depicts an example.

TABLE 17
Example syntax of a Repeat DSCS message.

| | Descriptor |
|---|---|
| digitally_signed_content_selection( payloadSize ) { | |
| dscs_id | u(8) |
| dscs_verification_substream_id | u(8) |
| if( more_data_in_payload( ) && payload_extension_present( ) ) { | |
| SeiExtensionBitsPresentFlag = 1 | |
| dscs_picture_segment_mode_flag | u(1) |
| if ( dscs_picture_segment_mode_flag ) | |
| dscs_skip_flag | u(1) |
| dscs_{—}repeat_{—}flag | u(1) |
| } | |
| } | |

dscs_repeat_flag equal to 1 indicates that the DSCS SEI messages in the previous AU with identical values of dscs_id and dscs_verification_substream_id of this DSCS SEI message, are implicitly repeated in the corresponding location (between the corresponding VCL NAL units) in the current AU, meaning, that each DSCS SEI message of the last AU is processed again for the selection of NAL units at this AU, without actually a need to exist in this AU. The same repeat of DSCS SEI messages continues if the next AUs contain a DSCS SEI message with dscs_repeat_flag=1. A DSCS SEI message with dscs_repeat_flag=1 may only be present before the first VCL NAL unit of an AU. In this case, no other DSCS SEI message with identical values of dscs_id and dscs_verification_substream_id shall exist in this AU.

Note that:
dscs_verification_substream_id specifies the verification substream ID of the verification substream to which the verification substream member NAL units in the current PU are assigned.

### Single DSCS Per Picture Unit (PU)

Another embodiment for DSCS combines all DSCS of a verification stream in a PU into a single DSCS. If a PU has NAL units, a subset of these NAL units is assigned to this PU. An inclusion array, as shown below, is created that shows which NAL units are included (the inclusion array value is set to 1.).

| | | | | | |
|---|---|---|---|---|---|
| NAL unit | 1 | 2 | 3 | . . . | N |
| Inclusion | 1 | 0 | 1 | | 0 |
| array | | | | | |

As shown in the Table, if a NAL unit has a value 1 in the inclusion table, it is included in the verification substream; otherwise (value 0), it is not included. Table 18 shows an example syntax of Single DSCS per PU.

TABLE 18
Single DSCS per PU

| | Descriptor |
|---|---|
| digitally_signed_content_selection( payloadSize ) { | |
| dscs_id | u(8) |
| dscs_verification_substream_id | u(8) |
| if( more_data_in_payload( ) && payload_extension_present( ) ) { | |
| SeiExtensionBitsPresentFlag = 1 | |
| dscs_picture_segment_mode_flag | u(1) |
| if ( dscs_picture_segment_mode_flag ){ | |
| dscs_skip_flag | u(1) |
| dscs_{—}num_{—}nalus_{—}minus1 | u(7) |
| for( i = 0; i <= dscs_{—}num_{—}nalus_{—}minus1; i++ ) | |
| dscs_{—}nalu_{—}included_{—}flag[ i ] | u(1) |
| } | |
| } | |
| } | |

dscs_num_nalus_minus1 plus 1 indicates the modulus number NAL units in the current PU, whose inclusion in this verification substream is provided by dscs_nalu_included_flag array.
dscs_nalu_included_flag[i] equals 1 indicates that the ith NAL unit from this SEI NAL is included in the calculation of the signature for this verification stream.
   Single DSCS Per Picture Unit (PU) for Combined with Modulo-n Operation

In an embodiment, the previous method can be combined with the modulo-n operation discussed earlier. This means that the DSCS appears at the beginning of the NAL units of a picture, and if the same pattern of verification stream is repeated in the following pictures, new DSCS does not need to be included with every picture. The DSCS is inferred from the first picture DSCS.

The following update to the semantics modulo-n repeat supports such functionality:
“When processing for selection, if a DSCS SEI exists in the current picture (DSCS-C), and if a DSCS SEI exists in the immediate prior picture (DSCS-P), that satisfy all the following conditions:
   Identical values for dscs_id in both DSCSs
   Identical values for dscs_verification_substream_id in both DSCSs
   dscs_picture_segment_mode_flag set to 1 in both DSCSs
Then the DSCS-C is processed for selection for the current picture. Otherwise, the DSCS-P is processed for selection for the current picture.”

As discussed earlier, Ref. [6] (JVET-A00197, to be referred also as the '197), was proposed as an alternative to the methods in TuC. Next, proposed embodiments improve upon the '197.

### Adding Picture Segment ID Signaling

The method in JVET-AO0197 does not signal the picture segment IDs in various segment sets. To address this functionality, for each segment set of each verification substream, it is proposed to signal the number of picture segments included in that segment set and the IDs of the picture segments. An example syntax for the proposed solution is shown in Table 19.

TABLE 19
Extending the ′197 DSCI to include picture segment IDs signaling

| | Descriptor |
|---|---|
| digitally_signed_content_initialization( payloadSize ) { | |
| dsci_id | u(8) |
| dsci_hash_method_type | u(8) |
| dsci_key_retrieval_mode_idc | ue(v) |
| if( dsci_key_retrieval_mode_idc = = 1 ) { | |
| dsci_use_key_register_idx_flag | u(1) |
| if( dsci_use_key_register_idx_flag ) | |
| dsci_key_register_idx | ue(v) |
| } | |
| dsci_content_uuid_present_flag | u(1) |
| if( dsci_content_uuid_present_flag ) | |
| dsci_content_uuid | u(128) |
| dsci_num_verification_substreams_minus1 | ue(v) |
| for( i = 1; i <= dsci_num_verification_substreams_minus1; i++ ) | |
| for( j = 0; j < i ; j++ ) | |
| dsci_ref_substream_flag[ i ][ j ] | u(1) |
| dsci_vss_implicit_association_mode_flag | u(1) |
| dsci_signed_content_start_flag | u(1) |
| dsci_sei_signing_flag | u(1) |
| while( !byte_aligned( ) ) | |
| dsci_alignment_zero_bit | f(1) |
| dsci_key_source_uri | st(v) |
| if( more_data_in_payload( ) && payload_extension_present( ) ) { | |
| SeiExtensionBitsPresentFlag = 1 | |
| dsci_same_num_segment_sets_flag | u(1) |
| if( dsci_same_num_segment_sets_flag ) | |
| dsci_common_num_segment_sets_minus2 | ue(v) |
| else | |
| for( i = 0; i <= dsci_num_verification_substreams_minus1; | |
| i++ ) | |
| dsci_num_segment_sets_minus1[ i ] | ue(v) |
| for(i = 0; i <= dsci_{—}num_{—}verification_{—}substreams_{—}minus1; i++ ) | |
| for(j = 0; j < SegmentsNumber [ j ]; j++ ){ | |
| dsci_{—}num_{—}segment_{—}minus1[ i ][ j ] | u(8) |
| for( k = 0; k <= dsci_{—}num_{—}segment_{—}minus1 [ i ][ j ]; | |
| k++ ) | |
| dsc_{—}pic_{—}segment_{—}id[ i ][ j ] | ue(v) |
| } | |
| } | |
| } | |

Where, proposed new syntax is shown in Italics, with the following new semantics.

The variable SegmentsNumber[i] is equal to the value of dsci_common_num_segment_sets_minus2+1 if dsci_same_num_segment_sets_flag is set to 1. Otherwise, it is equal to the value of dsci_num_segment_sets_minus1[i]+1.
dsci_num_segment_minus1[i][j] plus 1 indicates the number of separate coded picture segments in the j-th segment set that is associated with a verification substream with verification substream ID equal to dscs_verification_substream_id [i].
dsci_picture_segment_id[i][j] indicates a picture segment ID of a coded picture segment in the PU to which the SEI message applies, for which the coded picture segment is associated with the j-th segment set of the verification substream with verification substream ID equal to dscs_verification_substream_id [i]. The value of dscs_picture_segment_id [i][j] shall be in the range of 0 to 1023. For any integer m and n in the range of 0 to dsci_num_separate_picture_segment_minus1, inclusive, the dsci_picture_segment_id[i][m] value shall not be equal to the dsci_picture_segment_id[i][n] value.

### Adding the Modulo-n Feature

### Implicit Picture-Based Implementation

In an embodiment, if a DSCS does not appear in a new picture with the same ID as the one in the previous picture, an implicit DSCS is processed for this picture. The following semantics implements the above solution:
When processing for selection, if a DSCS SEI exists in the current picture (DSCS-C), and if a DSCS SEI exists in the immediate prior picture (DSCS-P), that satisfy all the following conditions:
   Identical values for dscs_id in both DSCS-C and DSCS-P
   Identical values for dscs_verification_substream_id in both DSCS-C and DSCS-P
   dscs_picture_segment_mode_flag set to 1 in both DSCS-C and DSCS-P
Then the DSCS-C is processed for selection for the current picture. Otherwise, the DSCS-P is processed for selection for the current picture.

### Explicit Modulo-n Picture Signaling

In another embodiment, one may explicitly signal the modulo-n operation but at the picture level. An example syntax is shown in Table 20.

TABLE 20
Modulo-n DSCS syntax for the ′197 proposal

| | Descriptor |
|---|---|
| digitally_signed_content_selection( payloadSize ) { | |
| dscs_id | u(8) |
| dscs_verification_substream_id | u(8) |
| if( more_data_in_payload( ) && payload_extension_present( ) ) { | |
| SeiExtensionBitsPresentFlag = 1 | |
| dscs_num_segment_sets_minus2 | ue(v) |
| dscs_delta_num_vcl_nalus | ue(v) |
| for( i = 1; i < dscs_num_segment_sets_minus2 + 2; i++ ) | |
| for( j = 0; j < dscs_num_segment_sets_minus2 + 1 + | |
| dscs_delta_num_vcl_nalus; j++ ) | |
| dscs_{—}nalu_{—}included_{—}in_{—}signature_{—}flag[ i ][ j ] | u(1) |
| dscs_{—}modulo_{—}n_{—}inclusion_{—}flag | u(1) |
| if(dscs_{—}modulo_{—}inclusion_{—}flag ) | |
| dscs_{—}modulo_{—}repeat | u(7) |
| } | |
| } | |

dscs_modulo_n_indusion_flag equal 1 indicates the inclusion of NAL units in this verification substream is signaled using a modulo picture pattern.
dscs_modulo_repeat equal to n, where 0<n<129, indicates at the n picture after this picture, this DSCS NAL unit is processed again, and the same repetition continues after every n picture until a DSCS with identical dscs_id and dscs_verification_substream_id values appear in the bitstream or the end of the verification period which is indicated with a DSCS with dscs_id and dscs_verification_substream_id values identical to this DSCS's, whichever comes first. The dscs_modulo_repeat equal to 0 indicates that this DSCS is processed once.

### Explicit Modulo-n NAL Signaling

In another embodiment, one may explicitly signal the modulo-n operation, but the modulo-n operation is applied to NAL units. The syntax is the same as in Table 20, but the semantics are updated to below.
dscs_modulo_n_indusion_flag equal 1 indicates the inclusion of NAL units in this verification substream is signaled using a modulo NAL unit pattern.
dscs_modulo_repeat equal to n, where 0<n<129, indicates at the n picture after this picture, this DSCS NAL unit is processed again, and the same repetition continues after every n NAL unit until a DSCS with identical dscs_id and dscs_verification_substream_id values appear in the bitstream or the end of the verification period which is indicated with a DSCS with dscs_id and dscs_verification_substream_id values identical to this DSCS's, whichever comes first. The dscs_modulo_repeat equal to 0 indicates that this DSCS is processed once.

### Adding Segment Set ID

In an embodiment, a unique ID for each segment set in DSCI, DSCS and in DSCV is added. The benefit is that if an extraction of one segment set is performed, no changes are needed in any of the SEIs and the SEIs can work as before. Examples of the proposed syntax are depicted in Tables 21-23.

TABLE 21
Adding a DSCI segment set ID to the ′197 proposal

| | Descriptor |
|---|---|
| digitally_signed_content_initialization( payloadSize ) { | |
| dsci_id | u(8) |
| dsci_hash_method_type | u(8) |
| dsci_key_retrieval_mode_idc | ue(v) |
| if( dsci_key_retrieval_mode_idc = = 1 ) { | |
| dsci_use_key_register_idx_flag | u(1) |
| if( dsci_use_key_register_idx_flag ) | |
| dsci_key_register_idx | ue(v) |
| } | |
| dsci_content_uuid_present_flag | u(1) |
| if( dsci_content_uuid_present_flag ) | |
| dsci_content_uuid | u(128) |
| dsci_num_verification_substreams_minus1 | ue(v) |
| for( i = 1; i <= dsci_num_verification_substreams_minus1; i++ ) | |
| for( j = 0; j < i ; j++ ) | |
| dsci_ref_substream_flag[ i ][ j ] | u(1) |
| dsci_vss_implicit_association_mode_flag | u(1) |
| dsci_signed_content_start_flag | u(1) |
| dsci_sei_signing_flag | u(1) |
| while( !byte_aligned( ) ) | |
| dsci_alignment_zero_bit | f(1) |
| dsci_key_source_uri | st(v) |
| if( more_data_in_payload( ) && payload_extension_present( ) ) { | |
| SeiExtensionBitsPresentFlag = 1 | |
| dsci_same_num_segment_sets_flag | u(1) |
| if( dsci_same_num_segment_sets_flag ) | |
| dsci_common_num_segment_sets_minus2 | ue(v) |
| else | |
| for( i = 0; i <= dsci_num_verification_substreams_minus1; | |
| i++ ) | |
| dsci_num_segment_sets_minus1[ i ] | ue(v) |
| for( i = 0; i <= dsci_num_verification_substreams_minus1; i++ ) | |
| for(j = 0; j < SegmentsNumber [ j ]; j++ ){ | |
| dsci_{—}segment_{—}set_{—}id[ i ][ j ] | u(8) |
| dsci_num_segment_minus1[ i ][ j ] | u(8) |
| for(k = 0; k <= dsci_num_segment_minus1[ i ][ j ]; | |
| k++ ) | |
| dsc_pic_segment_id[ i ][ j ] | ue(v) |
| } | |
| } | |
| } | |

dsci_segment_set_id[i][j] is a unique number that identifies the j-th segment set that is associated with a verification substream with verification substream ID equal to dscs_verification_substream_id [i].

TABLE 22
Adding a DSCS segment set ID to the ′197 proposal

| | Descriptor |
|---|---|
| digitally_signed_content_selection( payloadSize ) { | |
| dscs_id | u(8) |
| dscs_verification_substream_id | u(8) |
| if( more_data_in_payload( ) && payload_extension_present( ) ) { | |
| SeiExtensionBitsPresentFlag = 1 | |
| dscs_num_segment_sets_minus2 | ue(v) |
| dscs_delta_num_vcl_nalus | ue(v) |
| for( i = 1; i < dscs_num_segment_sets_minus2 + 2; i++ ) | |
| dscs_{—}segment_{—}set_{—}id[ i ] | u(8) |
| for( j = 0; j < dscs_num_segment_sets_minus2 + 1 + | |
| dscs_delta_num_vcl_nalus; j++ ) | |
| dscs_nalu_included_in_signature_flag[ i ][ j ] | u(1) |
| } | |
| } | |

dscs_segmnent_set_id[i] is a unique number that identifies the i-th segment set that is associated with a verification substream. This value shall be identical to the corresponding
dsci_segment_setjid[i][j] in DSCI with identical dscs_id as DSCS.

TABLE 23
Adding a DSCV segment set ID to the '197 proposal

| | Descriptor |
|---|---|
| digitally_signed_content_verification( payloadSize ) { | |
| dscv_id | u(8) |
| dscv_verification_substream_id | u(8) |
| dscv_signature_length_in_octets_minus1 | u(24) |
| dscv_signature | u(v) |
| dscv_signed_content_end_flag | u(1) |
| if( more_data_in_payload( ) && payload_extension_present( ) ) { | |
| SeiExtensionBitsPresentFlag = 1 | |
| dscv_num_segment_sets_minus2 | ue(v) |
| for( i = 1; i < dscv_num_segment_sets_minus2 + 2; i++ ) | |
| dscv_segment_set_id[ i ] | u(8) |
| dscv_signature_segment_set[ i ] | u(v) |
| } | |
| } | |

dscv_segment_set_id[i] is a unique number that identifies the i-th segment set that is associated with a verification substream. This value shall be identical to the corresponding dsci_segment_setjid[i][j] and dscs_segment_set_id[i] in DSCI and DSCS respectively, with identical dscs_id as DSCS.

### REFERENCES

Each one of the references listed herein is incorporated by reference in its entirety. The term JVET refers to the Joint Video Experts Team of ITU-T SG21 WP3/21 and ISO/IEC JTC 1/SC 29.
[1] ITU-T Rec. H.266, “Versatile Video Coding,” ITU-T, (v3) Sep. 2023
[2] J. Boyce, et al., “Additional SEI messages for VSEI version 4 (Draft 5),” JVET-AK2006, JVET 37^{th} Meeting, Geneva, CH, Jan. 2025.
[3] J. Boyce, et al., “Additional SEI messages for VSEI version 4 (Draft 7),” JVET-AM2006, JVET 39^{th} Meeting, Daejeon, KR, July 2025.
[4] S. McCarthy, et al. “Technologies under consideration for future extensions of VSEI (version 9),” JVET-AM2032, JVET 39^{th} Meeting, Daejeon, KR, July 2025.
[5] S. Deshpande, et al., “Technologies under consideration for future extensions of VSEI (version 10),” JVET-A02032, JVET 41^{th} Meeting, by teleconference, Jan. 2026.
[6] J. Boyce and M. M. Hannuksela, “AHG9: DSC subpicture support using segment sets,” JVET-A00197, JVET 41^{th} Meeting, by teleconference, Jan. 2026.

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to media authentication in video coding, such as those described herein. The computer and/or IC may compute any of a variety of parameters or values that relate to media authentication in video coding as described herein. The image and video embodiments may be implemented in hardware, software, firmware and various combinations thereof.

Certain implementations of the invention comprise computer processors which execute software instructions which cause the processors to perform a method of the invention. For example, one or more processors in a display, an encoder, a set top box, a transcoder, or the like may implement methods related to media authentication in video coding as described above by executing software instructions in a program memory accessible to the processors. Embodiments of the invention may also be provided in the form of a program product. The program product may comprise any non-transitory and tangible medium which carries a set of computer-readable signals comprising instructions which, when executed by a data processor, cause the data processor to execute a method of the invention. Program products according to the invention may be in any of a wide variety of non-transitory and tangible forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

### EQUIVALENTS, EXTENSIONS, ALTERNATIVES AND MISCELLANEOUS

Example embodiments that relate to media authentication in video coding are thus described. In the foregoing specification, embodiments of the present invention have been described with reference to numerous specific details that may vary from implementation to implementation. Thus, the sole and exclusive indicator of what is the invention, and what is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. (canceled)

2. A method to perform selective media authentication, the method comprising:
in decoder, receiving metadata in a digitally signed content selection (DSCS) message to enable authenticating video content associated with the DSCS message;
if a first DSCS message (DSCS-C) exists between (n-1)^{th} and n^{th} VCL NAL unit in the current access unit (AU), and if a second DSCS message (DSCS-P) exists between a (n-1)^{th} and a n^{th} VCL NAL unit of the immediate prior AU, and both messages satisfy all the following conditions:
identical values for dscs_id in both DSCS-C and DSCS-P;
identical values for dscs_verification_substream_id in both DSCS-C and DSCS-P;
dscs_picture_segment_mode_flag set to 1 in both DSCS-C and DSCS-P;
then the DSCS-C message is processed for selection for the n^{th} VCL NAL unit and subsequent NAL units, otherwise, the DSCS-P is processed for selection for the n-th VCL NAL unit and after the current AU.

3.-7. (canceled)

8. A method to perform selective media authentication, the method comprising:
in decoder, receiving metadata in a digitally signed content (DSC) message to enable authenticating video content associated with the DSC message;
accessing a DSC modulus number NAL parameter indicating a number of NAL units whose inclusion in a verification substream is provided by a NAL inclusion array, wherein a 1 in the i-th element of the NAL inclusion array indicates that the i-th NAL unit from the DSC message is included in calculating a signature for authenticating the video content.

9.-10. (canceled)

11. A method to perform selective media authentication, the method comprising:
in a decoder, receiving metadata in a digitally signed content (DSC) message to enable authenticating video content associated with the DSC message;
accessing a number of verification substreams for which message digests are calculated and signatures may be present in the DSC message; and
for each segment set of a verification substream,
accessing a unique number that identifies the j-th segment set that is associated with a verification substream with verification substream ID equal to dscs_verification_substream_id [i], or
accessing a unique number that identifies the i-th segment set that is associated with a verification substream.

12. A tangible computer-readable storage medium having stored thereon computer-executable instructions for executing with one or more processors a method in accordance with the method recited in claim 14.

13. An apparatus comprising a processor and configured to perform the method recited in claim 14.

14. A method to perform selective media authentication, the method comprising:
in decoder, receiving metadata in a digitally signed content selection (DSCS) message to enable authenticating video content associated with the DSCS message;
accessing a number of verification substreams for which message digests are calculated and signatures may be present in the DSCS message; and
for a verification substream:
for each AU, accessing a DSCS number NAL parameter indicating a number of VCL NAL units in the current AU whose inclusion in the verification substream is provided by a NAL inclusion array in the DSCS, wherein a 1 in the i-th element of the NAL inclusion array indicates that the i-th VCL NAL unit of the AU is included in calculating a signature for authenticating the video content for that verification substream; and
if the following AUs do not contain any DSCS message for the verification substream, then the DSCS message (DSCS-C) in this AU is also processed for selection of the VCL NAL units for each subsequent AU for this verification substream, until an AU with a new DSCS message is encountered.
